(19) United States
(12) Patent Application Publication
(10) Pub. No.: US 2018/0202464 A1
(43) Pub. Date: Jul. 19, 2018

(54) NOISE ATTENUATION FOR SYSTEMS WITH BLOWER WHEELS

(71) Applicant: Driessen Aircraft Interior Systems, Inc., Huntington Beach, CA (US)

(72) Inventors: Don Soutar, Newport Beach, CA (US); Wes Bredin, Huntington Beach, CA (US)

(73) Assignee: Driessen Aircraft Interior Systems, Inc., Huntington Beach, CA (US)

(21) Appl. No.: 15/872,470

(22) Filed: Jan. 16, 2018

Related U.S. Application Data
(60) Provisional application No. 62/446,887, filed on Jan. 17, 2017.

(51) Int. Cl. F04D 29/66

(52) U.S. Cl. CPC F04D 29/664; B60H 2001/006

(57) ABSTRACT

Embodiments of the present disclosure relate generally to noise attention systems for use in connection with air chiller systems or any other systems that incorporate a blower wheel for moving air through the system. In one example, because such systems incorporate a blower wheel that can create undesirable noise, there is provided a perforated housing or plate and a noise reducing cover in order to attenuate generated noise.

### CROSS REFERENCE TO RELATED APPLICATIONS

This application claims the benefit of U.S. Provisional Application Ser. No. 62/446,887, filed Jan. 17, 2017, titled “Noise Attenuation Muffler System for Aircraft Galley Air Chillers,” the entire contents of which are hereby incorporated by reference.

### FIELD OF THE DISCLOSURE

Embodiments of the present disclosure relate generally to noise attention systems for use in connection with air chiller systems or any other systems that incorporate a blower wheel for moving air through the system. In one example, because such systems incorporate a blower wheel that can create undesirable noise, there is provided a perforated housing or plate and a noise reducing cover in order to attenuate generated noise.

### BACKGROUND

Aircraft and other passenger transportation vehicles often incorporate one or more systems into their galleys that generate undesirable noise. For example, various HVACR (heating, ventilation, air conditioning, and refrigeration) units often incorporate blower wheels that are used to move air. More specifically, HVACR units may use centrifugal blower wheels that move air through ducting for air-conditioning. One type of HVACR unit, such as refrigeration unit, uses a centrifugal blower wheel to move air in order to refrigerate food or drink. The centrifugal blower wheel is used to generate air flow, which causes air turbulence, but this air turbulence also generates noise. Accordingly, beverage chillers, air chillers, and refrigeration units can often be a source of noise in the aircraft cabin.

### BRIEF SUMMARY

Accordingly, one object of this disclosure is to attenuate noise associated with systems that use blower wheels. Another object is to attenuate any additional noise that may be associated with the HVACR unit itself. In some examples, this disclosure provides systems designed to attenuate noise that may escape through a condenser air discharge and/or a condenser.

Embodiments of the disclosure described herein thus provide a sound attenuation system for a system that incorporates a blower wheel, the system comprising a blower wheel housing comprising a perforated housing or plate with a plurality of openings therein; and a sound reducing material positioned around the blower wheel housing. Further examples provide the sound reducing cover made of Nomex® material. Further examples provide the plurality of openings comprising about 40% to about 60% of the perforated housing. In a particular example, the plurality of openings comprise about 50% of the perforated housing. There may also be provided a cover shell that encloses the blower wheel housing or plate and the sound reducing material.

The blower wheel housing may have a cavity configured to house a blower wheel. Additionally, a cover (e.g., an air chiller cover) may be installed over the entire air chiller. The cover may be formed as a perforated plate having a U-shaped configuration and may also be associated with a sound reducing material.

This disclosure also provides a method for attenuating sound of a chiller mounted on board a passenger transportation vehicle, comprising: installing the sound attenuation system described herein in the chiller. The chiller may be a beverage chiller or an air chiller.

### BRIEF DESCRIPTION OF THE DRAWINGS

FIG. 1 shows a side perspective view of a perforated housing configured to house a blower wheel.

FIG. 2 shows a side perspective view of the perforated housing of FIG. 1 encased by a sound-attenuating cover. In this example, the housing is installed “within” an Air Chiller and attenuates noise generated by the blower wheel (due to air turbulence).

FIG. 3 shows an exploded perspective view of the housing and cover of FIG. 2, along with an intervening sound reducing material positioned therebetween.

FIG. 4 shows an exploded perspective view of a cover that may be used in connection with and used to cover over the housing of FIG. 1. This cover may be fabricated using a similar perforated plate as the housing, along with a sound reducing material, and it attenuates other noise generated from within the Air Chiller.

FIG. 5 shows a front perspective view of the cover of FIG. 4 having a sound-attenuating layer positioned therein.

FIG. 6 shows a front plan view of the housing cover of FIGS. 4 and 5.

### DETAILED DESCRIPTION

Embodiments of the present invention provide noise attenuation for systems with blower wheels. In one example, the noise attention system 10 includes a perforated housing 12, a sounds absorbing material 14, and a cover 14a, 14b. In use, the perforated housing 12 allows sound waves generated by a blower wheel housed within a cavity 16 of the housing to exit the housing 12. The sound-absorbing material 14 is made of any appropriate sound absorbing material that can absorb exiting sound waves, examples of which are described further herein. The cover 14a, 14b prevents air pressure from escaping through the sound absorbing material. This system 10 has been found to reduce the noise of other types of systems that may incorporate one or more sound-inducing features within.

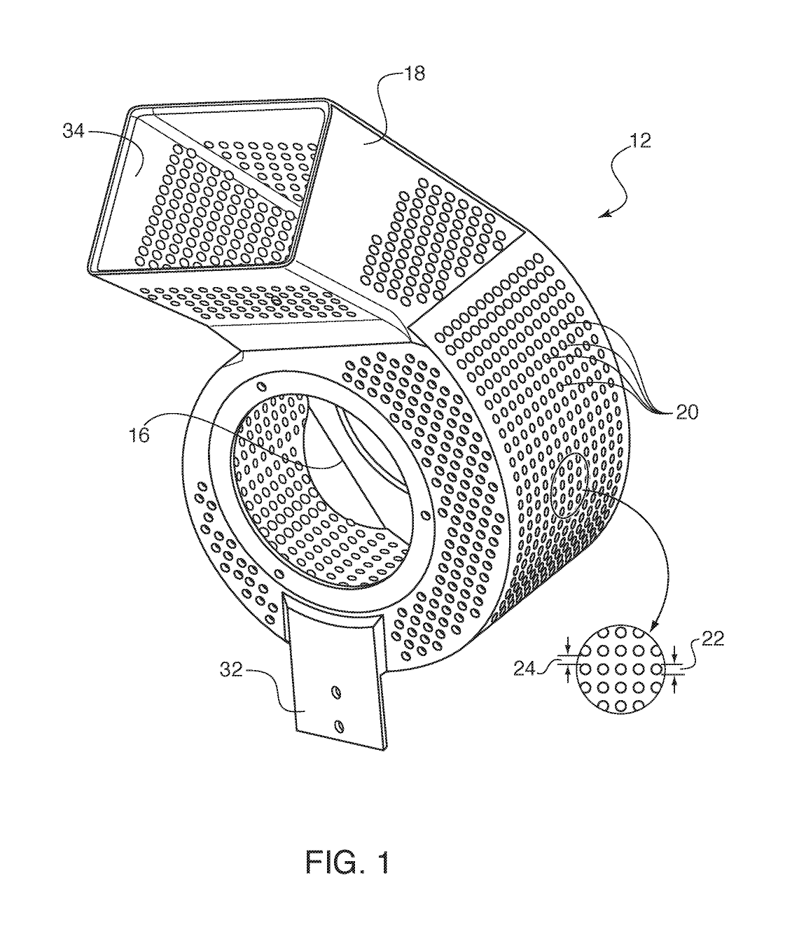

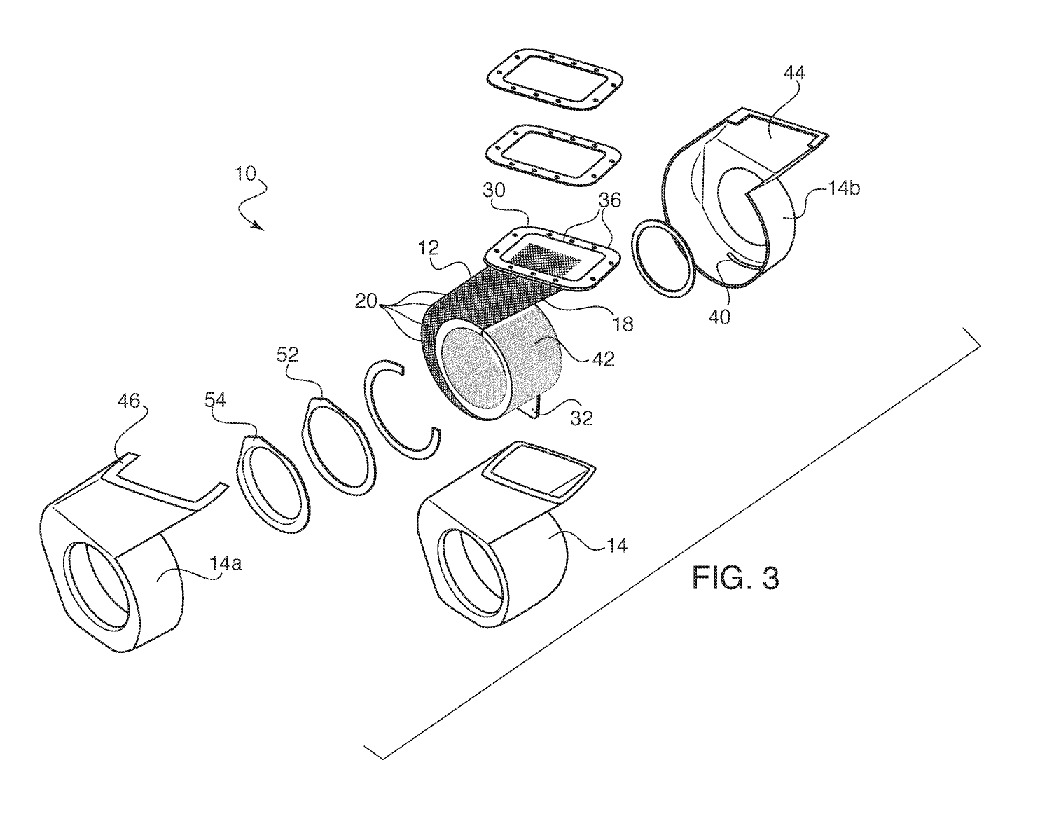

In the example illustrated by FIG. 1, the perforated housing 12 is shaped as a blower wheel housing, having a central circular cavity 16 configured to house a blower wheel (not shown). The housing 12 also has an exhaust feature 18. The exhaust feature 18 may be provided with an external flange 30, as illustrated by the example shown in the exploded view of FIG. 3. As described below, the external flange 18 can be used for mounting the housing to additional parts of an HVACR system. The housing 12 may also have a mounting bracket 32, which is also used for additional mounting purposes.

As illustrated, the housing 12 is provided as having a plurality of openings 20. In use, when a noise wave hits a solid surface, it tends to bounce back and continue to reverberate. If a noise wave traveling inside the perforated housing 12 hits a wall portion that is not perforated or otherwise does not have an opening 20, the wave will bounce back into the housing 12 and continue to travel or bounce. By contrast, if a noise wave enters an opening 20 of the housing, it is allowed to exit the housing 12. Its internal reverberation (or bouncing) is stopped.

The number and size of perforations in the housing 12 is optimized based on the requirement of structural support vs. openings that allow exiting of noise waves. Because the housing 12 is used as a pressure vessel, the number of openings 20 cannot be provided in a number that threatens or weakens the structure of the housing. Accordingly, a balance between support vs. noise attenuation is desirably achieved. Although examples of opening percentages are provided herein for the sake of description, it should be understood that these percentages may be varied depending upon the size and use of the system 10. While not wishing to be bound to any particular or specific percentages, the present inventors have found that a range of perforation percentage of between about 40% to about 60% may yield desirable results. In a particular example, a 51% perforated plate has been found to provide particularly successful results. It is believed, however, that it is possible to provide a perforation percentage that is greater or lesser than this amount and still achieve a beneficial result.

The dimensions of the openings 20 may be sized such that each opening diameter 22 is slightly larger than the length of the wall space 24 between each opening 20. In a specific example, the diameter of each opening may be about ⅔ greater than the length of the wall space. In other words, if an opening diameter 22 is about 2 cm, then the length of the wall space to the next opening may be about 0.660 cm. In another specific example, the opening diameters 22 may be about 0.1875″; with the center to center of adjacent openings being about 0.250″. In this example, the area between two adjacent openings is about 0.0625″ (or about ⅓ of the hole diameter).

It is also possible for the openings 20 to be provided as having varied sizes from one another. It is also possible for the space 24 between openings to be approximately the same as or larger than the diameter 22 of the openings 20 themselves. Various optimizations are possible and considered within the scope of this disclosure.

As illustrated by FIGS. 1 and 3, there are fewer (to no) openings 20 positioned along the end edge 34 of the exhaust feature 18. It has been found that the longer the length that the “air tube with perforations” section can be made, the more enhanced noise attenuation can be achieved. However, one reason for fewer openings at this edge location 34 in this location is to prevent air from escaping the blower wheel housing at areas where the cover 14a, 14b does not reach the flange 30 (in order to accommodate for the length of nutplates on flange 30).

In one example, the housing 12 may be molded. In another example, the housing 12 may be welded. In another example, the housing 12 may be 3-D printed.

Possible materials for the housing 12 include but are not limited to Aluminum, Ultem, Polycarbonate, or combinations thereof. These materials have been found useful because they all pass Federal Aviation Administration (FAA) Fire Properties and Flammability requirements. However, it should be understood that other plastics can also be used.

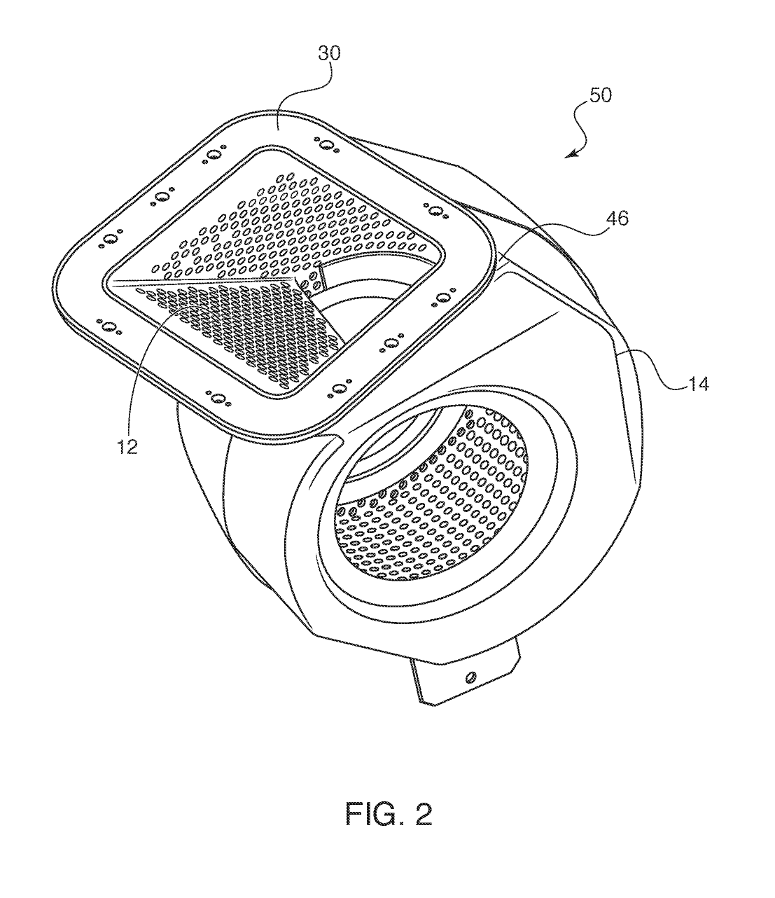

Referring now to FIGS. 2 and 3, the housing 12 is encased, enclosed, or otherwise contained within a sound-attenuating material 14. In a specific example, the material 14 may be provided in two halves. This can ease manufacturing of the system 10, as well as ease any maintenance or repairs that may need to be conducted once the system 10 has been assembled. Then, as illustrated by FIG. 3, an outer case or final product cover 14a, 14b may be provided over the sound reducing material 14. The final cover 14a, 14b is shown as having a first portion 14a and a second portion 14b. The portions 14a, 14b are generally mirror images of one another and are designed to mate around the housing 12/material 14 assembly. Specifically, each portion 14a, 14b has an internal cavity 40 designed similarly in shape as the body 42 of the housing 12/material 14. Each portion 14a, 14b also has a corresponding exhaust feature cavity 44 that is shaped similarly to and receives the exhaust feature 18 of the housing 12/material 14.

The sound reducing material 14 and the cover 14a, 14b may be mechanically secured to the housing 12. In one example, it is possible for halves of the sound reducing the material 14 to be friction fit over the housing 12. They may also be adhered to the housing using any other appropriate manner. If adhered using an adhesive, however, it is generally recommended that the adhesive not fill or encroach on any of the openings 20, to avoid creating another hard surface off of which sound would bounce, rather than traveling through the opening 20. In other examples, the material 14 may be screwed, riveted, bolted, or secured to the housing 12 using any appropriate fasteners. The cover portions 14a, 14b are then positioned around the material 14. The portions 14a, 14b may be screwed, riveted, bolted, or secured to the housing 12 using any appropriate fasteners. In another example, the cover portions 14a, 14b are adhered to the material 14 using an appropriate adhesive. In a further example, the material 14 may be formed into or otherwise positioned within each of the cover halves 14a, 14b, such that only a single placement step need be conducted.

As shown by FIG. 3, the cover portions 14a, 14b may be designed so that the upper exhaust edge 46 is a flat surface that is secured underneath the flange 30 of the housing 12 upon assembly of the components to one another. The upper exhaust edge 46 may rest flush with or otherwise abut the lower surface of the flange 30.

Possible materials for the sound reducing material 14 include but are not limited to Nomex®, acoustic foam, any other sound reducing material, or combinations thereof. In a specific example, the material 14 is manufactured of Nomex®, which is a poly (m-phenylenediamine isophthalamide) material manufactured and sold by DuPont™. Nomex® is a heat- and flame-resistant material that is generally used for protective fabrics, garments, insulation, and other high-performance applications. To the inventors' knowledge, this material has not been used or explored for sound attenuation or sound-reducing properties.

In a specific example, the thickness of the material 14 ranges from between about 0.1 inches to about 1.0 inch. In a particular example, the thickness of the material 14 ranges from between about 0.25 inches to about 0.5 inches. In a further specific example, the thickness of the material 14 ranges from about 0.125-0.750 inches. In another specific example, the thickness of the material 14 ranges from about 0.060-0.100 inches. In a further example, the thickness of the material ranges from about 0.185-0.600.

The outer case cover 14 may be polycarbonate, ultem, aluminum, aluminum tape, or any other appropriate cover material that can protect the system and contain the air pressure thereof. This protective shell/cover 14a, 14b encloses the completed assembly of the housing 12 and the sound reducing material 14. This cover 14 may be manufactured by molding, thermoforming, or any appropriate manufacturing method.

As illustrated, the flange 30 may have one or more mounting features 36 configured to mount the scroll housing 12/sound reducing material 14/cover 14a and 14b (collectively referred to as assembly 50) to cover 70. (A hard duct from the Aircraft Environmental Control System (ECS) will then be attached to the opening 78 in the cover 70, from which the blower wheel air exhaust exits.) FIG. 3 also illustrates a series of doublers 52 and an inlet ring 54 that are used for attachment and securement of the components to one another. As illustrated, the inlet rings 54 may have smooth radii, which may help encourage smooth entry of air in order to reduce turbulence upon entry. Once assembled, the assembly 50 functions to attenuate noise generated by the blower wheel fan function.

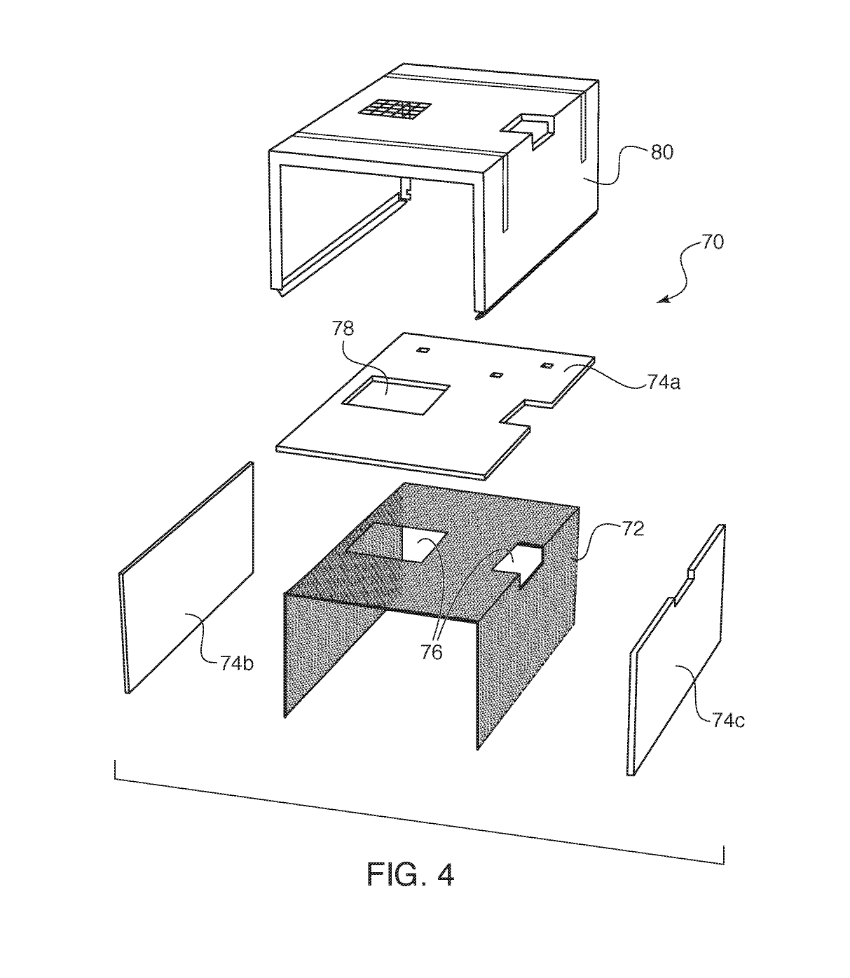

FIG. 4 illustrates an alternate embodiment incorporating the features described. This example provides an air chiller cover muffler 70. (When used herein, the term “chiller” or “air chiller” is intended to include chillers such as Horizontal Air Chillers, Vertical Air Chillers, and Slim Air Chillers, terms which are used in the industry to refer to dimensions for certain types of chillers based on where they are dimensioned or otherwise designed to fit, whether onto or into a cavity, of an aircraft galley.) The cover muffler 70 includes a perforated plate 72. The perforated plate 72 may have similar ranges and dimensions as described above for the perforated housing 12. In the example shown, the perforated plate 72 generally has a U-shaped configuration that allows it to fit over air chiller components. The air chiller cover muffler 70 is also provided with a layer of sound-attenuating material 74. The sound-attenuating material 74 may have similar properties as described above for the material 14. In a specific example, the material 74 is a one or more layers of Nomex® material. The material 74 may be configured to match any appropriate configuration of the perforated plate 72. As illustrated, the perforated plate 72 has a series of component openings 76, and the material 74 has corresponding component openings 78. FIG. 4 also shows an upper material layer 74a, and side material layers 74b, 74c. It should be understood that material 74 may be provided as a single integral piece, or it may be provided in a plurality of components or parts as shown.

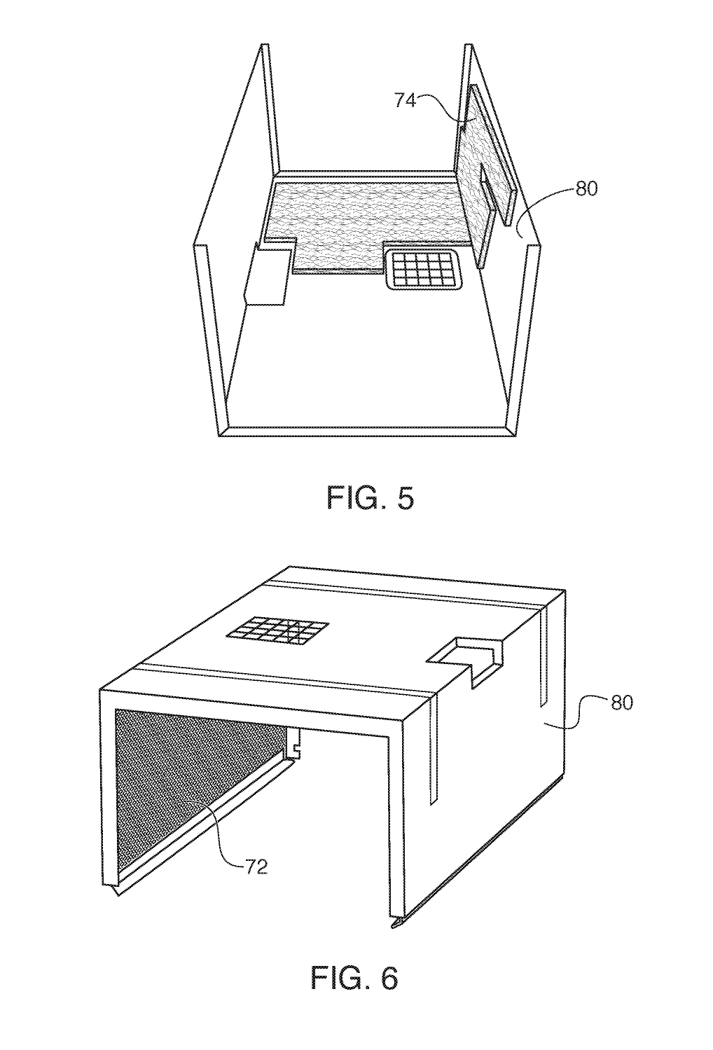

A shell 80 is also provided. Shell 80 has similar shape and dimensions as perforated plate 72. Shell 80 is configured to be positioned over the perforated plate 72 and material 74. In another example, the material(s) 74 may be layered or otherwise secured within the shell 80, as shown in FIG. 5. FIG. 6 illustrates a completed assembly.

In both of the examples described, the cover 14 or shell 80 helps additionally attenuate noise and preventing air from escaping the system. Accordingly, regardless of the shape provided, the general intent of this disclosure is to provide a perforated element that is enclosed, encased, or otherwise housed by a sound-attenuating cover. In specific examples, the sound-attenuating cover is made of Nomex® material. A cover shell may be provided over that completed assembly.

Although specific embodiments have been disclosed, it should be understood that changes and modifications, additions and deletions may be made to the structures and methods recited above and shown in the drawings without departing from the scope or spirit of the disclosure or the following claims.

What is claimed is:

1. A sound attenuation system for a system that incorporates a blower wheel, the system comprising:
a blower wheel housing comprising a perforated housing with a plurality of openings therein; and
a sound reducing material positioned around the blower wheel housing.

2. The system of claim 1, wherein the sound reducing cover comprises Nomex® material.

3. The system of claim 1, wherein the plurality of openings comprise about 40% to about 60% of the perforated housing.

4. The system of claim 3, wherein the plurality of openings comprise about 50% of the perforated housing.

5. The system of claim 1, wherein the blower wheel housing comprises a blower housing with a cavity configured to house a blower wheel.

6. The system of claim 1, wherein the sound attenuation system is used in connection with a chiller system, further comprising a cover installed over the chiller system, wherein the cover comprises a perforated plate with a U-shaped configuration.

7. The system of claim 1, further comprising a cover shell enclosing the blower wheel housing and the sound reducing material.

8. The system of claim 7, wherein the cover shell comprises a perforated plate and sound reducing material.

9. A method for attenuating sound of a chiller mounted onboard a passenger transportation vehicle, comprising:
installing the sound attenuation system of claim 1 in the chiller.

10. The method of claim 9, wherein the chiller comprises a beverage chiller or an air chiller.
